(19) United States
(12) Patent Application Publication
(10) Pub. No.: US 2023/0020661 A1
(43) Pub. Date: Jan. 19, 2023

(54) SYSTEMS AND METHODS FOR CALCULATING ENGAGEMENT WITH DIGITAL MEDIA

(71) Applicant: LimeSpring LLC, Boxford, MA (US)

(72) Inventors: Harry R. GOLDBERG, Boxford, MA (US); Charles Z. GOLDBERG, Boulder, CO (US)

(21) Appl. No.: 17/812,284

(22) Filed: Jul. 13, 2022

Related U.S. Application Data
(60) Provisional application No. 63/203,248, filed on Jul. 14, 2021.

(51) Int. Cl. G09B 7/00

(52) U.S. Cl. CPC G09B 7/00

(57) ABSTRACT

Systems and methods for measuring user engagement with subject matter content are disclosed. One computer-implemented method may include: receiving, at a computer system, an indication to calculate a user engagement score with respect to a subject matter unit; determining, via an algorithm, a value for one or more behavioral variables associated with the user for the subject matter unit; generating, by aggregating the value for each of the one or more behavioral variables, the user engagement score for the subject matter unit; and performing, based on the generated user engagement score, an action.

### CROSS-REFERENCE TO RELATED APPLICATIONS

This application claims the benefit of priority from U.S. Provisional Patent Application No. 63/203,248, filed Jul. 14, 2021, which is hereby incorporated by reference herein in its entirety.

### TECHNICAL FIELD

Various embodiments of the present disclosure pertain generally to data processing methods. More specifically, particular embodiments of the present disclosure relate to systems and methods for processing data associated with electronic media to calculate engagement.

### BACKGROUND

The performance of individuals engaged in course work and other educational and training programs (e.g., students, employees, hobbyists, etc.) is generally quantified by an evaluation of the individuals' performance metrics (i.e., their results on graded assessments such as quizzes and tests, etc.). For many individuals, this post hoc analysis may cause corrective action to be taken too late for substantial improvement to be made. Furthermore, in many situations it may be difficult or impossible for an instructor to determine the cause of poor performance. Additionally, analysis of engagement may indicate that different individualized approaches are necessary to generate improvement in performance. The present disclosure is accordingly directed to identifying the causes for an individual's performance.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for measuring user compliance and/or engagement with subject matter content.

In one aspect, a computer-implemented method for measuring user compliance and/or engagement with subject matter content is disclosed, the computer-implemented method comprising operations including: receiving, at a computer system, an indication to calculate a user engagement score with respect to a subject matter unit; determining, via an algorithm, a value for one or more behavioral variables associated with the user for the subject matter unit; generating, by aggregating the value for each of the one or more behavioral variables, the user engagement score for the subject matter unit; and performing, based on the generated user engagement score, an action.

In another aspect, a system for measuring user engagement and/or compliance with subject matter content is disclosed, the system including: at least one memory storing instructions; at least one processor configured to execute the instructions to perform operations, the operations comprising: receiving an indication to calculate a user engagement score with respect to a subject matter unit; determining, via an algorithm, a value for one or more behavioral variables associated with the user for the subject matter unit; generating, by aggregating the value for each of the one or more behavioral variables, the user engagement score for the subject matter unit; and performing, based on the generated user engagement score, an action.

In yet another aspect, a non-transitory computer-readable medium storing computer-executable instructions which, when executed by a processor, cause the processor to perform operations including: receiving, at a computer system, an indication to calculate a user engagement score with respect to a subject matter unit; determining, via an algorithm, a value for one or more behavioral variables associated with the user for the subject matter unit; generating, by aggregating the value for each of the one or more behavioral variables, the user engagement score for the subject matter unit; and performing, based on the generated user engagement score, an action.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts an exemplary flowchart of a method of calculating a user engagement score and performing an action in response thereto, according to one or more embodiments.

FIG. 3 depicts an exemplary course work summary page, according to one or more embodiments

FIG. 4 depicts an exemplary quiz time delay graph, according to one or more embodiments.

FIG. 5 depicts an exemplary assessment effort graph, according to one or more embodiments.

FIG. 6 depicts an exemplary content viewing speed chart, according to one or more embodiments.

FIG. 7 depicts an exemplary rewind occurrence chart, according to one or more embodiments.

FIG. 8 depicts an exemplary Boolean chart, according to one or more embodiments.

FIGS. 9A-C depict exemplary four-quadrant matrices, according to one or more embodiments.

FIG. 10 depicts an exemplary computing server, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “individual” may be used interchangeably with other terms such as “user” or “student”, unless explicitly delineated otherwise. Relative terms, such as, “substantially” and “generally,” are used to indicate a possible variation of ±10% of a stated or understood value.

As used herein, a “machine-learning model” generally encompasses instructions, data, and/or a model configured to receive input, and apply one or more of a weight, bias, classification, or analysis on the input to generate an output. The output may include, for example, an analysis based on the input, a prediction, suggestion, or recommendation associated with the input, a dynamic action performed by a system, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

Conventional techniques for evaluating an individual's educational performance are generally assessment-focused in nature. For example, a student's comprehension of a topic may be assessed by administration of an exam (e.g., a quiz, a test, etc.). The student's score on the exam may provide an indication of how well they grasped the subject matter and/or may be further used to differentiate that student from others (e.g., other individuals in the student's class, etc.). Taken alone, however, the exam score fails to provide an explanation regarding the student's performance on the exam.

Identifying attributes of individual behavior that can be used to explain an individual's performance in a course may be challenging for those overseeing the individual's progress in the course, such as an instructor. For instance, in a conventional classroom setting, an instructor is generally focused on lecturing/teaching and may not be able to effectively monitor each of their students' behaviors (e.g., to determine if a student is unfocused, chatting with others, engaging in other unrelated activities, etc.). These difficulties may be further exacerbated in an online teaching setting in which an instructor is not in physical proximity to their students and might not be able to visually monitor their actions. Furthermore, in either an in-person or online teaching setting, instructors are rarely privy to the time and/or effort a student dedicates to the subject matter outside of the classroom.

To address the above-noted problems, the present disclosure describes a system that may monitor a user's engagement with a course of study to identify attributes of user behavior that may be leveraged to explain, improve, or otherwise alter performance. More particularly, the techniques disclosed herein go beyond post hoc quantitative assessment of user performance in that they may include factors that lead to or influence user success. Accordingly, causation for performance may be more reliably determined and interventions or other actions may be taken to improve performance or increase the likelihood of other desired outcomes. Techniques described herein may accordingly allow for enhanced training and education via assessment of users based on both performance and effort.

As will be discussed further herein, users may be scored on multiple metrics, such as performance and effort. Performance may be assessed using quantitative results on graded assessments whereas effort may be assessed using an algorithm that determines a user's engagement score based on quantitative and qualitative variables and that may consider a user's unique learning preferences (e.g., audio, visual, kinesthetic, text-based) in performing the analysis and/or in the proposed approach to improving outcomes. The user may then be mapped to a matrix comparing performance to effort to provide insight into outcomes and determine the best method for engaging the user to improve overall results. The matrix may also be used to assess performance and engagement and make individualized adjustments to delivery mechanisms and interventions to improve engagement scores and may correspondingly result in better performance outcomes. A recommendation engine may also exist that may be configured to dynamically provide instructors, and other individuals responsible for overseeing a user's progress within a course, with suggestions on how to improve performance based on one or more metrics, including performance and/or effort. In an embodiment, the engagement score may be utilized alone or in coordination with the recommendation engine to provide automated notifications to users (e.g., instructors, students).

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

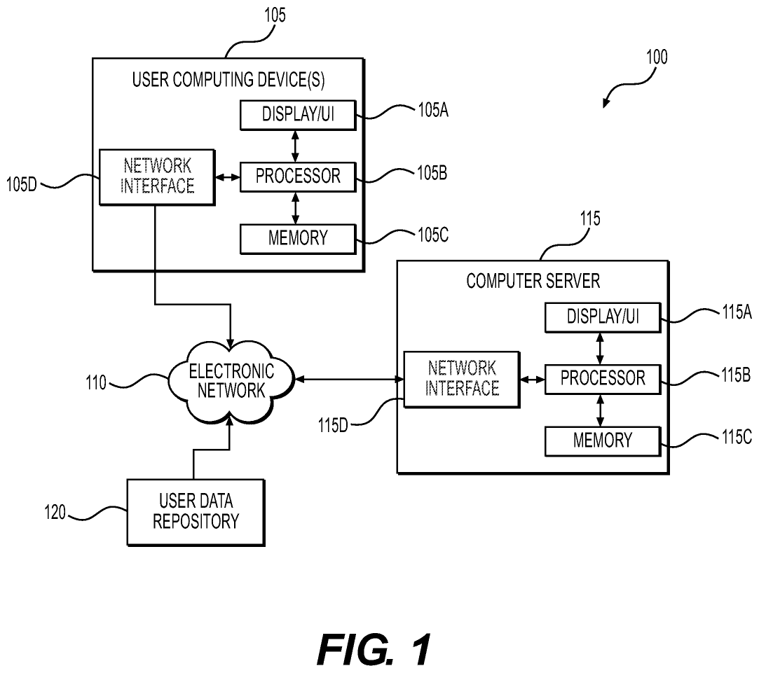

FIG. 1 depicts an exemplary block diagram of a system environment 100 configured to calculate user engagement with digital media, according to one or more embodiments of the present disclosure. The system environment 100 may include one or more user computing device(s) 105, an electronic network 110, a computer server 115, and a user data repository 120.

The user computing device(s) 105, the server 115, and/or the user data repository 120 may be connected via the network 110, using one or more standard communication protocols. The server 115 may be configured to receive data over the network 110 from the user computing device(s) 105, including, but not limited to, application interaction data and/or user assessment data. The application interaction data and/or the user assessment data may be stored in the user data repository 120, and may include information such as behavioral variables associated with a user, algorithms for the calculation of the behavioral variables, algorithms for the calculation of a total user engagement score, weighting information for any of the behavioral variables, unit scores for one or more subject matter units, and the like. The server 115 may store the application interaction data and/or the user assessment data received over the network 110 in user data repository 120.

In one or more embodiments, the computer server 115 and the user data repository 120 may be one server computer device and a single database, respectively. Alternatively, in one or more embodiments, the server 115 may be a server cluster, or any other collection or network of a plurality of computer servers. The user data repository 120 also may be a collection of a plurality of interconnected databases. The server 115 and the user data repository 120 may be components of one server system. Additionally, or alternatively, the server 115 and the user data repository 120 may be components of different server systems, with the network 110 serving as the communication channel between them (as illustrated). The computer server 115 and the user data repository 120 may be associated with an entity, such as an educational instruction application (not shown). In some embodiments, the computer server 115 and/or the user data repository 120 may collectively be referred to as an entity system.

As shown in FIG. 1, the computer server 115 may be in communication with the user computing device(s) 105 to transmit and receive data, messages, and/or instructions from each other across the network 110. The user computing device(s) 105 may be associated with users who are registered with an educational instruction application provided by the computer server 115. The network 110 may comprise one or more networks that connect devices and/or components of environment 100 to allow communication between the user computing device(s) 105, the computer server 115, and other associated components. For example, the network 110 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of environment 100. In some embodiments, the network 110 may be implemented using cell and/or pager networks, satellite, licensed radio, or a combination of licensed and unlicensed radio. The network 110 may be associated with a cloud platform that stores data and information related to methods disclosed herein.

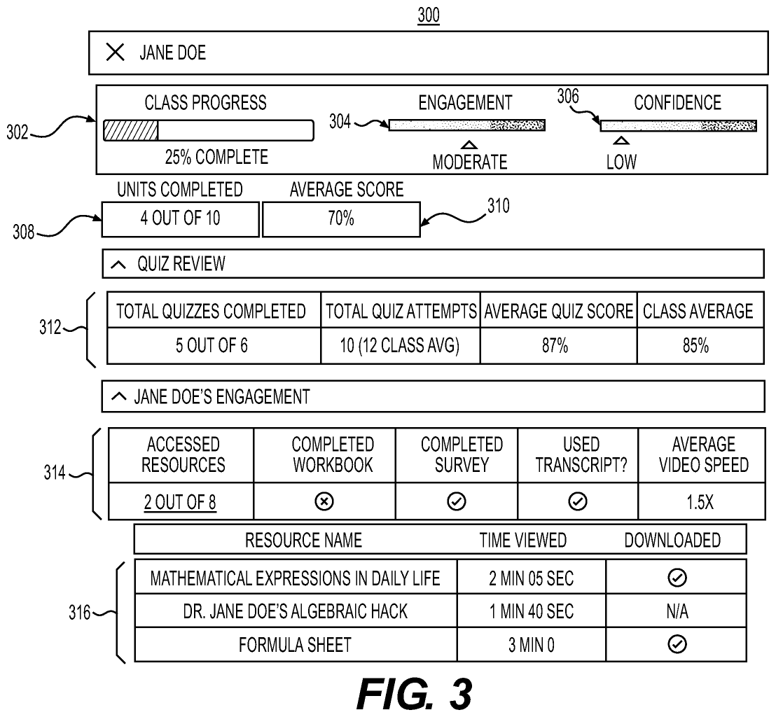

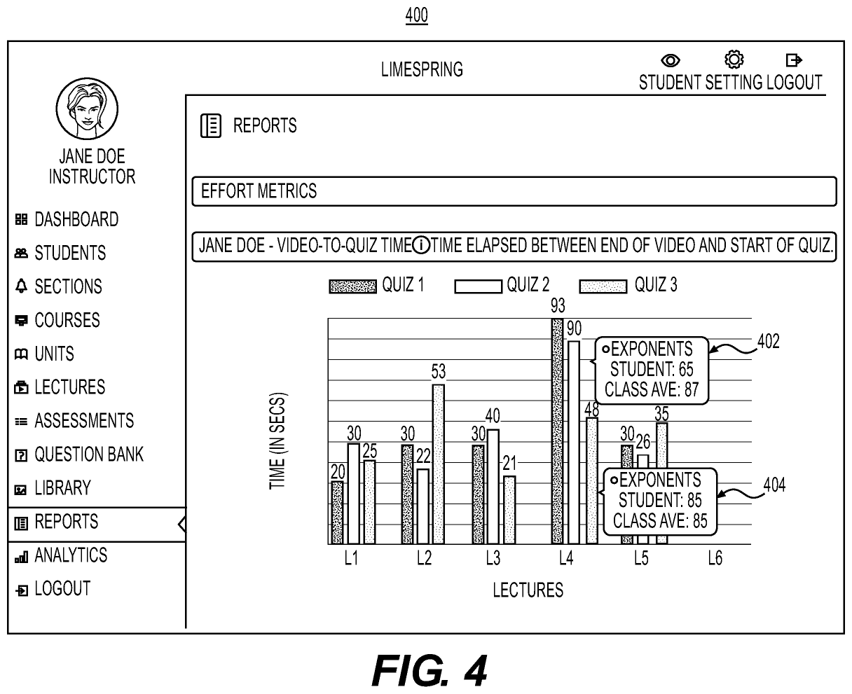

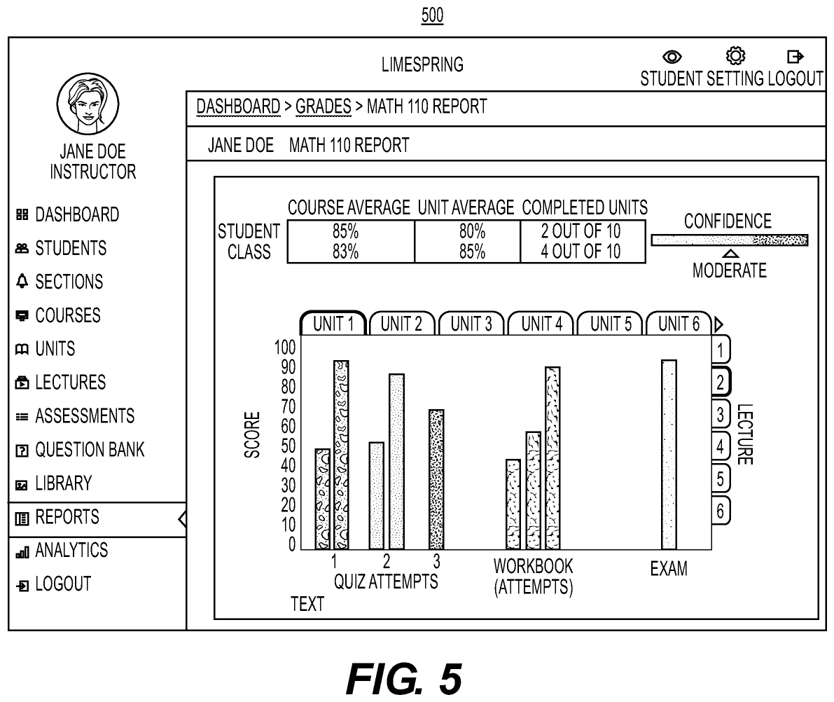

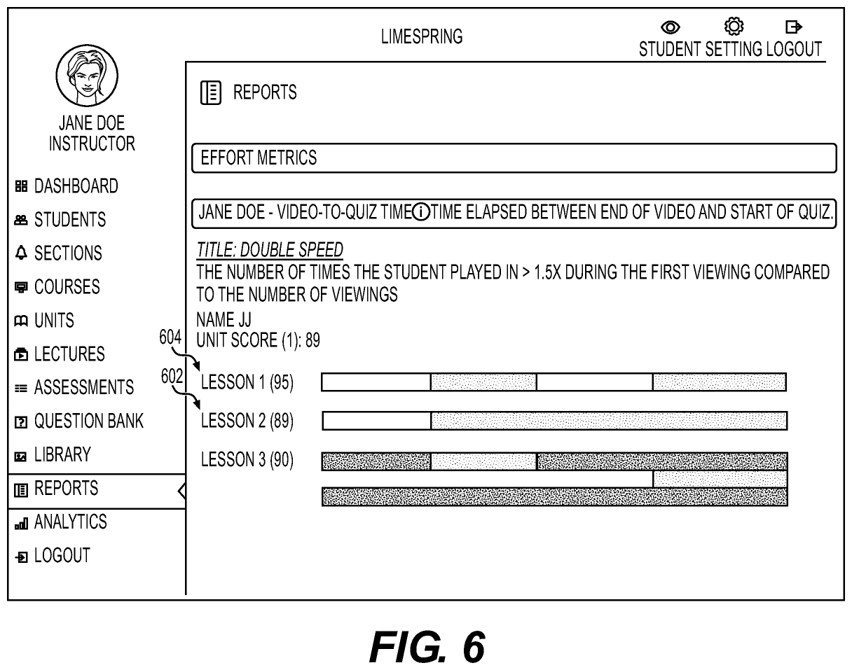

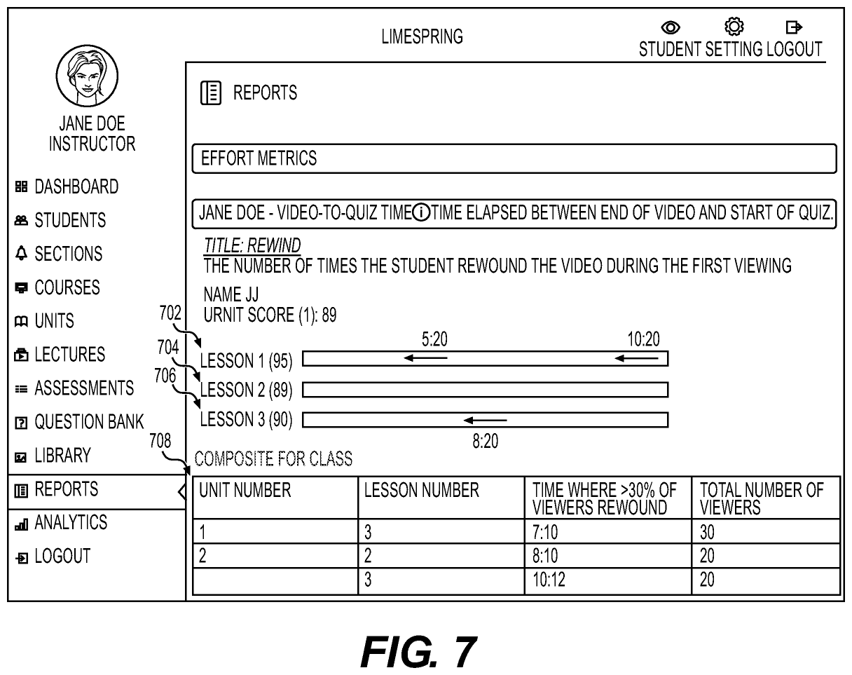

The user computing device(s) 105 may include a display/user interface (UI) 105A, a processor 105B, a memory 105C, and/or a network interface 105D. The user computing device(s) 105 may be a personal computer (PC), a tablet PC, a set-top box (STB), a streaming device (e.g., Apple TV®, Amazon Fire®, Roku® player, Google Chromecast®), a television (TV), a smart TV, a gaming console, a personal digital assistant (PDA), a mobile device, a palmtop computer, a laptop computer, a desktop computer, etc. The user computing device(s) 105 may execute, by the processor 105B, an operating system (O/S) and at least one application (each stored in memory 105C). The application may be a browser program or a mobile application program (which may also be a browser program in a mobile O/S). The application may perform one or more actions, such as, for example, the generation of graphs or plotting matrices shown in FIGS. 3-9, based on instructions/information received from the server 115. In some embodiments, the application may perform one or more actions based on instructions/information stored in the memory 105C. The one or more actions performed by the application may be application GUIs for the application executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the network 110. The processor 105B, while executing the application, may receive user inputs from the display/UI 105A, and perform actions or functions in accordance with the application or other related applications.

The computer server 115 may include a display/UI 115A, a processor 115B, a memory 115C, and/or a network interface 115D. The server 115 may be a computer, system of computers (e.g., rack server(s)), and/or or a cloud service computer system. The server 115 may execute, by the processor 115B, an operating system (O/S) and at least one instance of a server program (each stored in memory 115C). The server 115 may store or have access to information from user data repository 120. The display/UI 115A may be a touch screen or a display with other input systems (e.g., mouse, keyboard, etc.) for an operator of the server 115 to control the functions of the server 115 (e.g., update the server program and/or the server information). The network interface 115D may be a TCP/IP network interface for, e.g., Ethernet or wireless communications with the network 110. The server program, executed by the processor 1156 on the server 115, may be configured to generate a user engagement score based on values associated with one or more behavioral variables, as further described herein.

As described above, the computer server 115 may store application interaction data and/or user assessment data for users subscribed to or registered to the educational instruction application associated with the computer server 115. For instance, the computer server 115 may store user profiles generated by the computer server 115 for the user(s). In some embodiments, the information described above, including the application interaction data and/or user assessment data and any additional data received from user computing devices 105, may be stored in a plurality of user profiles within the user data repository 120. Each user profile may correspond to a specific user in communication with the server 115. In an embodiment, a user may have multiple user computing devices 105 registered with the server 115 based on the user's viewing habits and/or preferences. For example, one user may register a personal laptop, a smart TV, and a mobile device with the server 115. Information associated with registered user computing device(s) 105 and the user's viewing habits and/or viewing preferences may all be stored within the user's user profile.

In some embodiments, in addition to the application interaction data and/or user assessment data, each user profile may also include information associated with a respective user and their user computing device(s) 105 (e.g., a device identifier, device type), the user's name, a username or a nickname provided by the user for the user profile, educational preference indications provided by the user, and/or other user analytics generated by the server 115. In these embodiments, the user profile may be updated to reflect a corresponding user's recent activities.

In the system environment 100, the computer server 115, may retrieve various types of user data from the user data repository 120 to generate artifacts (e.g., graphical constructions, recommendation notifications, etc.) that may thereafter be sent to the user computing device(s). In some embodiments, the user data repository 120 may be maintained by third party content providers. In other embodiments, the user data repository 120 may be maintained by the server 115 and/or additional servers associated with the server 115. In an embodiment, the computer server 115 may analyze the data in the user data repository 120 in order to, for example, generate an engagement score for a user during a subject matter unit.

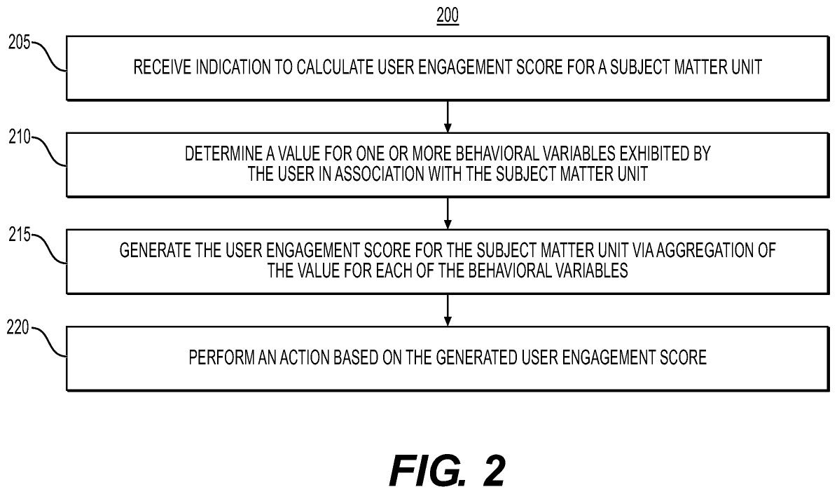

FIG. 2 depicts an exemplary process flow 200 for performing an action based on a generated engagement score for a user, according to one or more embodiments of the present disclosure. The exemplary process flow 200 may be implemented by system environment 100, which includes user computing device(s) 105 associated with users, computer server 115, and user data repository 120 (all shown in FIG. 1).

At step 205, an indication to calculate a user engagement score for a subject matter unit may be received at the computer server 115. In the context of this application, a subject matter unit may correspond to a predetermined set of subject matter (e.g., subject matter associated with a specific topic, subject matter taught over a predetermined period of time, subject matter that spans a predetermined number of chapters or lectures, etc.) and the user engagement score may correspond to an objective indication of a user's effort with respect to their performance in the subject matter unit. In an embodiment, the indication may be received in response to detection of a user command. For example, an instructor wanting to see a particular student's user engagement score with respect to a subject matter unit in an online course may interact with an educational instruction application on their device (e.g., via selecting a user engagement score generation button or option, etc.). In another embodiment, the indication may be received in response to detection of a predetermined event (e.g., a passage of a predetermined period of time, a conclusion of a subject matter unit, a receipt of a grade/score assigned in the subject matter unit, etc.).

In an embodiment, a unit score assigned to a user for the subject matter unit may also be identified. In the context of this application, a unit score may correspond to a received score or grade that a user received for the subject matter unit. Stated differently, the unit score may be representative of a user's objective performance in the subject matter unit. In an embodiment, the unit score may be a single assigned score or, alternatively, may be an accumulation of two or more scores obtained by the user in various graded assessments over the course of the subject matter unit. In situations of the latter, the unit score may be an average of the two or more scores.

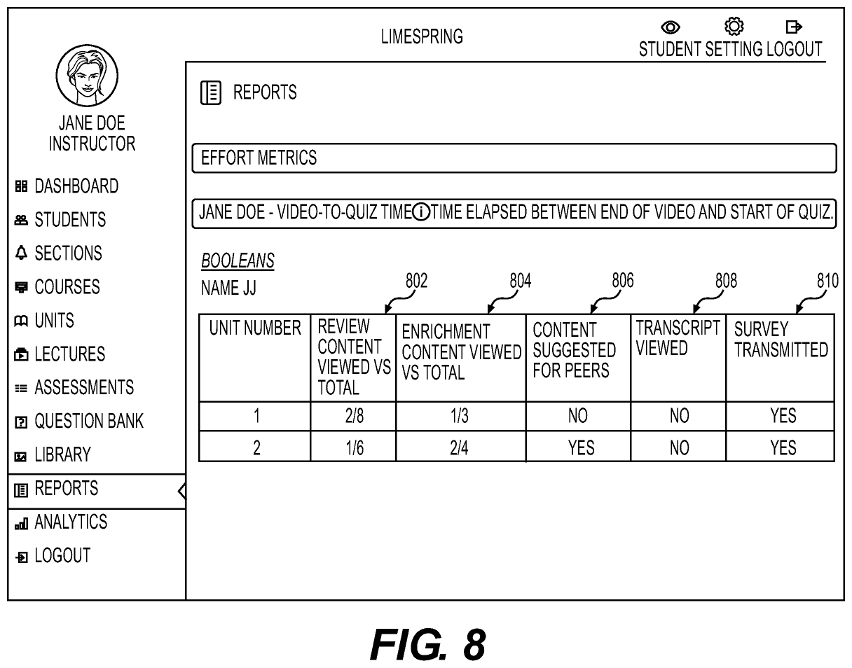

At step 210, an embodiment may determine a value for one or more behavioral variables exhibited by the user in association with the subject matter unit. In the context of this application, a behavioral variable may be a metric that is reflective of a user's effort and/or engagement associated with an aspect of study. A sampling of behavioral variables may include:
a. Quiz Time Delay: The delay between the time a quiz, or other performance assessment, is presented and the time the user first engages with the quiz or assessment.
b. Quiz effort: The number of times quizzes or other performance assessments are retaken may be factored into the engagement score.
c. Workbook effort: The number of times workbooks are retaken may be factored into the engagement score.
d. Play speed: The percentage of time the user spends watching the video in accelerated or slowed speed, may be factored into the engagement score.
e. Rewinds: The number of times the video is rewound or rewatched may be considered in the engagement score. Video pauses, fast forwards, and/or replays may also be considered alternatively or in combination.
f. Contribution: The number of contributions the user makes, for example to a group activity, which may be for the benefit of the user or his/her peers. This factor may also be recorded as a Boolean or flag.
g. Enrichment: The number of times the user requests, views or engages with enrichment content as a percentage or portion of total enrichment opportunities may be factored into the engagement score.
h. Review: The number of times the user requests, views or engages with review content, for example as a percentage or portion of total review opportunities. This metric may be factored into the engagement score.
i. Transcript: Whether the transcript was viewed by the user may be used as a Boolean and may be factored in the engagement score.
j. Survey: Whether a course survey or other feedback was submitted by the user may be used as a Boolean and may be factored in the engagement score. Multiple course surveys may also be considered. Other Booleans may be considered, with FIG. 8 illustrating examples.

It is important to note that the behavioral variables listed above are non-limiting, and that other behavioral variables, not explicitly mentioned or described in this disclosure, may also be considered and analyzed.

In an embodiment, visual representations of these behavioral variables may be generated by the computer server 115 and may be presented to a user (e.g., via an application interface on the user's device) in order to quickly apprise the user of certain types of engagement information. For instance, referring now to FIG. 3, an exemplary course work summary page 300 is illustrated. The course work summary page 300 may be generated by the computer server 115 and may contain information associated with a variety of student course work metrics. For example, the course work summary page 300 may provide an indication of how far a user has progressed through a course 302, what their engagement was with the course so far 304, how confident the student felt while completing the coursework 306, the number of units of coursework completed 308, the average score across the completed coursework units 310, quiz data information 312, engagement information 314, and resource access information 316.

In another embodiment, an exemplary quiz time delay graph 400 may be presented. The quiz time delay graph 400 may provide an indication of how much time has passed between the end of a lecture set and the initiation of a quiz associated with that lecture set. Such information may be considered a factor in the determination of student compliance or engagement, with the implication being that frequent long delays in video-to-quiz time may be representative of less student engagement. For instance, an examination of the data 402 associated with Quiz 2 in Lecture 4 reveals that a student has scored poorly on the quiz relative to their classmates and their quiz time delay was 90 seconds. In contrast, the data 404 associated with Quiz 3 indicates that the student performed much better when their quiz time delay was lower (i.e., to 40). In the interest of clarity, this metric may be viewed on a per assessment basis or aggregated across multiple assessments.

In another embodiment, an assessment effort graph 500 may be presented. The assessment effort graph 500 may provide an indication of how many times a quiz, or other performance assessment (e.g., workbook, exam, etc.), was retaken by a student. This metric has various implications since in some instances the more times a user retakes an assessment, the more engaged they are with the subject matter, while in other instances, the more times a user retakes an assessment may be an indication that the user is retaking assessments due to poor performance, a negative indicator. Inspection of the quiz effort graph 500 may confirm that the second time a user takes a quiz or workbook, the higher they score. When a student retakes an assessment multiple times, higher scores do not necessarily capture poor engagement or behavioral metrics.

In another embodiment, a content viewing speed chart 600 may be presented. The content viewing speed chart 600 may provide an indication of how often a user views content above a normal speed (e.g., at 1.5× speed or above) during the first viewing. Additionally, the content viewing speed chart 600 may further provide an implication of which portions of the content the user has sped through. The implication with this metric may be that the more often a user views content at higher speeds, the less engaged they are with the lesson (e.g., because they may be speeding through important topics). Inspection of the content viewing speed chart 600 may confirm this implication. For example, a user that speeds through a majority of the content, as illustrated in the content viewing speed chart 600 for Lesson 2 602, may score less than when they watch more of the content in normal speed, such as in Lesson 1 604. When algorithmically coupled with other metrics, such as performance on assessments, viewing speed may indicate that the user is appropriately engaging with the content (e.g., a user who performs well on the assessment after viewing at 1.5× speed is engaging appropriately, while a user who performs poorly on the assessment after viewing at 1.5× speed is engaging poorly).

In another embodiment, a rewind occurrence chart 700 may be presented. The rewind occurrence chart 700 may provide an indication of the number of times a student rewound a lesson video during the first viewing. The implication with this metric may be that several short rewinds during an initial viewing indicates that they are engaged with the lesson. For example, the user for Lesson 1 702 rewound the lesson video twice and scored a 95, the user for Lesson 3 706 rewound the lesson video once and scored a 90, and the user for Lesson 2 704 did not rewind the lesson video at all and scored the lowest out of the three lesson sets. Frequent or long rewinds may indicate that the user is becoming distracted or having a low level of engagement with the content. In an embodiment, the rewind occurrence chart 700 may additionally include a table 708 that provides an indication of the point in each lecture video at which more than a predetermined number of viewers rewound the video, perhaps provide an indication that the subject matter at that video portion is complicated and/or confusing.

In another embodiment, a Boolean chart 800 may be presented. The Boolean chart 800 may provide an indication of various additional behavioral variable metrics for each unit, including: The number of times the user requests, views or engages with review content 802, the number of times the user requests, views or engages with enrichment content as a percentage or portion of total enrichment opportunities 804, the number of times the user requests, views or engages with review content 806, an indication of whether a transcript was viewed by a user 808, and an indication of whether a course survey or other feedback was submitted by the user 810.

In an embodiment, the values for each of the behavioral variables may be calculated by using an algorithm that compares quantitative performance metrics and quantitative and qualitative variables that are observed during instruction based on user behavior, such as the behavioral variable described above. In an embodiment, the value for each behavioral variable may be identified by utilization of a unique algorithm for that behavioral variable. Characteristics of each algorithm may be adjustable by a user, instructor, or system administrator (e.g., cut-off thresholds, point allocations). Provided below are a plurality of sample algorithms for calculating values associated with the aforementioned behavioral variables. Algorithms may return quantitative or qualitative results.

Example of Single Variable Calculation

Quiz Time Delay

Quiz_Grade=questions answered correctly/total number of questions

Time_Delay=time between presentation of quiz start prompt and start of quiz

If Quiz_Grade is less than 88% and Time_Delay is
Greater than 10 s then 0;
Between 5 s and 10 s then 2;
Less than 5 s then 3;

Else then null

Example of Multivariate Calculation

Quiz Effort Calculation

Quiz_Grade=questions answered correctly/total number of questions

Time_Delay=time between presentation of quiz start prompt and start of quiz

Quiz_Retakes=number of times quiz retaken
If Time_Delay>10 s and Quiz_Retakes>2 then low;
Else if Quiz_Grade>90% then high;
Else if Quiz_Grade>80% then medium;
Else low

At step 215, the user engagement score for the subject matter unit may be generated. In an embodiment, the generation of the user engagement score may be facilitated by aggregating the values associated with each of the behavioral attributes. In an embodiment, the engagement score may be calculated by using an algorithm that compares variables across metrics (e.g., performance, behavioral) and assignments. In an embodiment, the engagement score may be compared to an average score to benchmark the individual, potentially to inform or to make recommendations. In situations where only a single behavioral attribute value exists, the single behavioral attribute value may be the user engagement score.

In an embodiment, a weighting factor may be applied to any of the behavioral attribute values. More particularly, any of the values may be emphasized or de-emphasized based on, for instance, user preferences. Additionally or alternatively, the assigned weights for the behavioral attributes may be adjusted dynamically using a machine learning model, which may be trained, for example, using past user engagement data. In an embodiment, the weights applied to any of the behavioral attributes may be continually updated based on new user data, which may be used to iteratively retrain the system.

At step 220, an action may be performed by the computer server 115 based on the generated user engagement score. In the context of this application, the action may inform a particular individual or group of individuals, for example, an instructor (e.g., teacher, tutor, manager, etc.), administrator, a user's parent and/or guardian, and/or the individual themselves, about the reason(s) behind the individual's performance and/or may provide insight regarding how the individual's performance may be improved. For instance, in an embodiment, the action may correspond to the generation and transmission of one or more automated notifications or communications. More particularly, the system may contain a recommendation engine that provides recommendations for how to improve performance. The recommendation engine may be configured to generate and/or transmit these recommendations at one or more predetermined times. For example, a recommendation may be transmitted to an instructor responsive to identifying that a student's generated engagement score for a subject matter unit has: fallen below a predetermined threshold, deviated by greater than a threshold amount from previous engagement scores generated for other subject matter units, deviated by greater than a threshold amount from an average engagement score associated with other students enrolled in the course, and the like.

In another embodiment, the performance of the action may correspond to the construction, by the computer server 115, of a visual representation of a relationship between the individual's objective performance (i.e., their unit score) and their quantitative and/or qualitative effort leading to the performance result (i.e., their user engagement score). For instance, the computer server 115 may generate one or more matrices (e.g., a four-quadrant matrix) that may contain plot points that are representative of the performance:effort ratio of various individuals (e.g., students), units, lectures, etc.

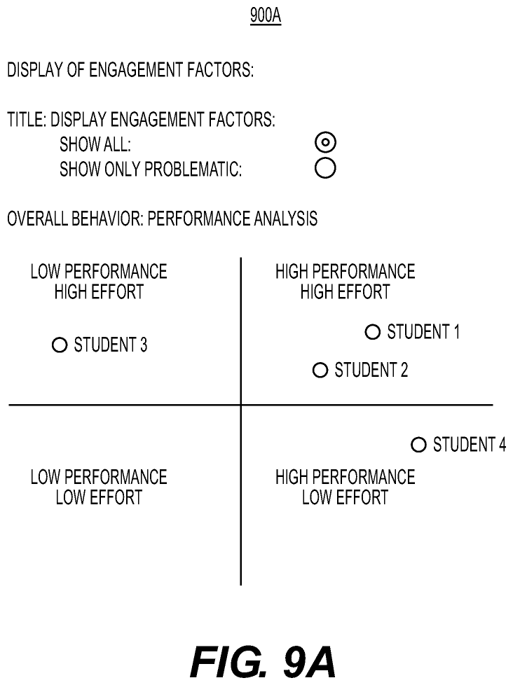

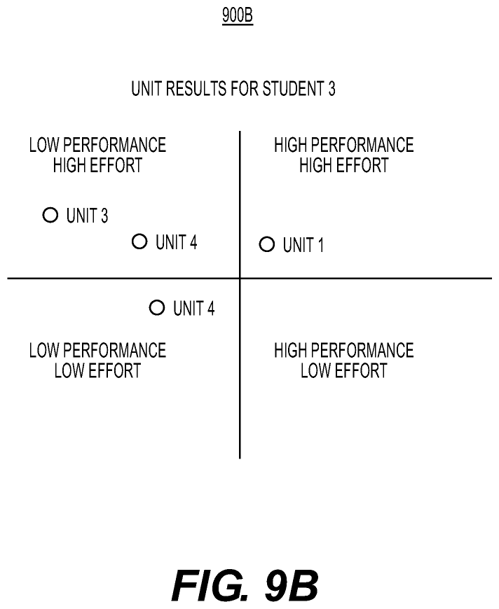

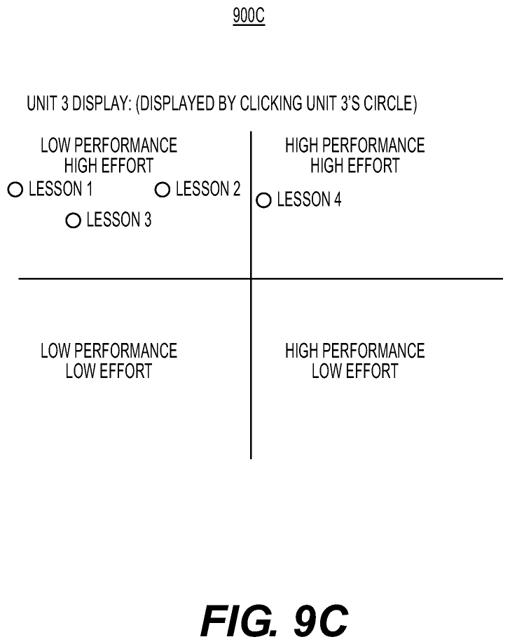

As an example of the foregoing, turning now to FIG. 9A, an exemplary illustration of a four-quadrant matrix 900A is provided. Each quadrant of the four-quadrant matrix 900A may be broadly representative of a ratio category (e.g., low performance: high effort, high performance:high effort, low performance:low effort, and high performance; low effort). The four-quadrant matrix 900A may contain a plurality of plotted points that are each representative of the performance:effort ratio of a student (i.e., students 1-4) for the entire course. For instance, students 1 and 2 exhibited high effort and performed well in the course, student 3 exhibited high effort but performed poorly in the course, and student 4 performed well in the course but exhibited low effort. Such a diagram may enable an individual (e.g., an instructor, etc.) to quickly identify the circumstances associated with each student and may thereafter enable them to address each student's needs in a more personalized and tailored way. For instance, the four-quadrant matrix 900A provides an indication that student 3, who is shown to have performed poorly with respect to their effort, may not have been studying in the correct way. As another example, the four-quadrant matrix 900A may provide an indication that student 4, who has performed well in the course despite exhibiting limited effort, may not be challenged enough by the subject matter and may need to receive move advanced instruction. In an embodiment, a mastery-based approach may be utilized to promote efficiency, prioritizing performance over effort, potentially using effort as a secondary measure to diagnose changes in performance over time.

In an embodiment, the computer server 115, may be able to generate more granular data for a student based upon user interactions. For example, turning now to FIG. 9B, an exemplary illustration of another four-quadrant matrix 900B is provided. Four-quadrant matrix 900B may be generated in response to a user selecting (e.g., clicking on, etc.) “Student 3” in the four-quadrant matrix 900A depicted in FIG. 9A. Upon selection of “Student 3”, four-quadrant matrix 900B may be generated that provides an indication of the performance:effort ratio that was associated with Student 3 for each unit in the course. To obtain even more granular data, selection of one of the units presented on the four-quadrant matrix 900B (e.g., selection of Unit 3) may generate another four-quadrant matrix 900C (as illustrated in FIG. 9C) that provides plotted indications of the performance:effort ratio that was associated with Student 3 for each lecture in Unit 3.

In an embodiment, the type of granulized data access described above and illustrated in FIGS. 9A-C may better enable an instructor to identify why a student is performing as they are and may also help them to better tailor lesson plans for that student. In an embodiment, the computer server 115, may aid the instructor by generating for them (e.g., upon selection of a particular plotted student) dynamic recommendations for actions that they can take to improve a student's performance. Additionally or alternatively, the computer server 115 may automatically transmit a notification to a user (e.g., if a student's performance:ratio score falls bellows a predetermined threshold) providing them with a tailored recommendation based on analysis of that user's individual effort, performance, or both scores.

In general, any process discussed in this disclosure that is understood to be computer-implementable, such as the process illustrated in FIG. 2, may be performed by one or more processors of a computer server, such as computer server 115, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer server. A processor may be a central processing unit (CPU), a graphics processing unit (GPU), or any suitable types of processing unit.

A computer system, such as computer server 115, may include one or more computing devices. If the one or more processors of the computer system are implemented as a plurality of processors, the plurality of processors may be included in a single computing device or distributed among a plurality of computing devices. If a computer server 115 comprises a plurality of computing devices, the memory of the computer server 115 may include the respective memory of each computing device of the plurality of computing devices.

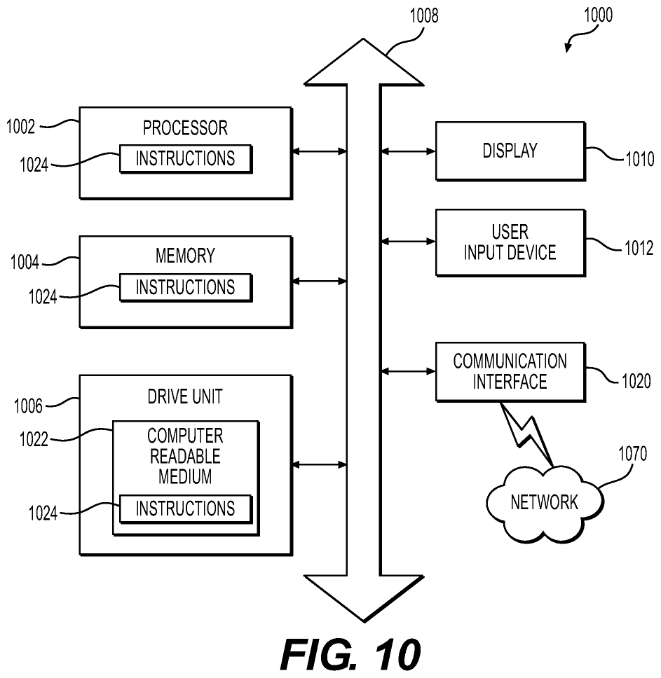

FIG. 10 is a simplified functional block diagram of a computer system 800 that may be configured as a computing device for executing the process illustrated in FIG. 2, according to exemplary embodiments of the present disclosure. FIG. 10 is a simplified functional block diagram of a computer that may be configured as the computer server 115 according to exemplary embodiments of the present disclosure. In various embodiments, any of the systems herein may be an assembly of hardware including, for example, a data communication interface 1020 for packet data communication. The platform also may include a central processing unit (“CPU”) 1002, in the form of one or more processors, for executing program instructions. The platform may include an internal communication bus 1008, and a storage unit 1006 (such as ROM, HDD, SDD, etc.) that may store data on a computer readable medium 1022, although the system 1000 may receive programming and data via network communications. The system 1000 may also have a memory 1004 (such as RAM) storing instructions 1024 for executing techniques presented herein, although the instructions 1024 may be stored temporarily or permanently within other modules of system 1000 (e.g., processor 1002 and/or computer readable medium 1022). The system 1000 also may include input and output ports 1012 and/or a display 1010 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to calculating engagement with digital media in an instructive setting, it should be appreciated that the presently disclosed embodiments may be applicable to monitoring user engagement with other types of content (e.g., during meeting presentations, etc.) and may be applicable to any environment, such as a desktop or laptop computer, any CTV (connected TV) environment (e.g., an internet-connected device used to watch multimedia content items), etc. Also, the presently disclosed embodiments may be applicable to any type of Internet protocol.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the process shown in FIG. 10, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for measuring user compliance and/or engagement with subject matter content, the computer-implemented method comprising operations including:
receiving, at a computer system, an indication to calculate a user engagement score with respect to a subject matter unit;
determining, via an algorithm, a value for one or more behavioral variables associated with the user for the subject matter unit;
generating, by aggregating the value for each of the one or more behavioral variables, the user engagement score for the subject matter unit; and
performing, based on the generated user engagement score, an action.

2. The computer-implemented method of claim 1, further comprising presenting, on an application of a user device associated with the computer system, a visual representation of the one or more behavioral variables.

3. The computer-implemented method of claim 1, wherein the algorithm leverages at least one performance assessment score and at least one variable associated with user behavior or engagement.

4. The computer-implemented method of claim 1, wherein the algorithm is unique for each of the one or more behavioral variables.

5. The computer-implemented method of claim 1, wherein the one or more behavioral variables correspond to at least one of: a quiz time delay metric, a quiz effort metric, a workbook effort metric, a viewing speed metric, a rewind metric, a contribution metric, an enrichment metric, a content review metric, a transcript viewing metric, and a survey completion metric.

6. The computer-implemented method of claim 1, wherein the generating the user engagement score comprises applying a weighting metric to the value for each of the one or more behavioral variables.

7. The computer-implemented method of claim 1, wherein the performing the action comprises:
constructing a visual representation of a relationship between a unit score for the subject matter unit and the user engagement score for the subject matter unit; and
transmitting, responsive to the constructing, instructions to at least one user device to display the visual representation in an application associated with the computer system.

8. The computer-implemented method of claim 7, wherein the visual representation corresponds to a four quadrant matrix comprising a plot point representative of the relationship.

9. The computer-implemented method of claim 1, wherein the performing the action comprises:
generating a recommendation for a subsequent action the user can take to increase one or more of: a subsequent subject matter unit score and/or the user engagement score; and
transmitting, responsive to generating the recommendation, instructions to at least one user device to display the recommendation on an application associated with the computer system.

10. The computer-implemented method of claim 9, wherein the recommendation is automatically generated in response to identification of a predetermined event associated with the user engagement score.

11. A system for measuring user engagement and/or compliance with subject matter content, the system comprising:
at least one memory storing instructions;
at least one processor configured to execute the instructions to perform operations, the operations comprising:
receiving an indication to calculate a user engagement score with respect to a subject matter unit;
determining, via an algorithm, a value for one or more behavioral variables associated with the user for the subject matter unit;
generating, by aggregating the value for each of the one or more behavioral variables, the user engagement score for the subject matter unit; and
performing, based on the generated user engagement score, an action.

12. The system of claim 11, further comprising presenting, on an application of a user device associated with the system, a visual representation of the one or more behavioral variables.

13. The system of claim 11, wherein the algorithm leverages at least one performance assessment score and at least one variable associated with user behavior.

14. The system of claim 11, wherein the algorithm is unique for each of the one or more behavioral variables.

15. The system of claim 11, wherein the one or more behavioral variables correspond to at least one of: a quiz time delay metric, a quiz effort metric, a workbook effort metric, a viewing speed metric, a rewind metric, a contribution metric, an enrichment metric, a content review metric, a transcript viewing metric, and a survey completion metric.

16. The system of claim 11, wherein the generating the user engagement score comprises applying a weighting metric to the value for each of the one or more behavioral variables.

17. The system of claim 11, wherein the performing the action comprises:
constructing a visual representation of a relationship between a unit score for the subject matter unit and the user engagement score for the subject matter unit; and
transmitting, responsive to the constructing, instructions to at least one user device to display the visual representation in an application associated with the system.

18. The system of claim 17, wherein the visual representation corresponds to a four quadrant matrix comprising a plot point representative of the relationship.

19. The system of claim 11, wherein the performing the action comprises:
generating a recommendation for a subsequent action the user can take to increase one or more of: a current subject matter unit score, a subsequent subject matter unit score and/or the user engagement score; and
transmitting, responsive to generating the recommendation, instructions to at least one user device to display the recommendation on an application associated with the system,
wherein the recommendation is automatically generated in response to identification of a predetermined event associated with the user engagement score.

20. A non-transitory computer-readable medium storing computer-executable instructions which, when executed by a processor, cause the processor to perform operations comprising:
receiving, at a computer system, an indication to calculate a user engagement score with respect to a subject matter unit;
determining, via an algorithm, a value for one or more behavioral variables associated with the user for the subject matter unit;
generating, by aggregating the value for each of the one or more behavioral variables, the user engagement score for the subject matter unit; and
performing, based on the generated user engagement score, an action.
